(19) United States
(12) Patent Application Publication
(10) Pub. No.: US 2015/0230622 A1
(43) Pub. Date: Aug. 20, 2015

(54) Devices for prevention of bed bug infestations and elimination of existing bed bug infestations, and methods of preventing bed bug infestations and eliminating existing bed bug infestations.

(71) Applicant: George Orbelian, San Francisco, CA (US)

(72) Inventor: George Orbelian, San Francisco, CA (US)

(21) Appl. No.: 14/622,082

(22) Filed: Feb. 13, 2015

Related U.S. Application Data
(60) Provisional application No. 61/940,697, filed on Feb. 17, 2014.

(51) Int. Cl. A47C 31/00; A47C 7/62; A47C 21/04; A01M 1/22

(52) U.S. Cl. CPC A47C 31/007; A01M 1/226; A47C 7/62; A47C 21/048

(57) ABSTRACT

This invention provides heating devices for eliminating bedbugs. The devices include commonly infested items of furniture with heating elements built in, such that a user concerned about preventing infestations or treating an existing infestation needs only to “plug in” the item to a wall socket and the furniture is heated beyond the mortal limits of bed bugs. A preferred embodiment of the invention is a mattress with heating coils on either its outer surface and/or an inner surface under some of the padding. The heating coils are controlled by a thermostat capable of regulating heat such that it can generate temperatures of at least 113 to 120 degrees Fahrenheit, which is suitable for killing bed bugs at all stages of their life cycle.

### CROSS REFERENCE TO RELATED APPLICATIONS

This application claims priority back to U.S. Provisional Application No. 61/940,697, filed Feb. 17, 2014, a copy of which is attached to this application and the contents of which are incorporated by reference into the current application.

### STATEMENT REGARDING FEDERALLY SPONSORED RESEARCH OR DEVELOPMENT

This invention was not federally sponsored.

### BACKGROUND OF THE INVENTION

1. Field of the Invention

This invention relates to the general field of devices and methods for the prevention of bed bug infestations and elimination of existing bed bug infestations, and more specifically toward a variety of devices and methods that use heat to kill existing bed bugs and prevent infestation of previously uninfested areas by bed bugs.

One of the common nighttime rhymes many parents say to their children before they go to sleep is “Good night, sleep tight, don't let the bed bugs bite”. The ironic thing about this rhyme is that bed bugs have not been a major problem in most of the United States for the lifetime of many of these parents who are telling the rhyme.

The history of the bed bug is both interesting and disturbing. The first records of bed bugs date back to ancient Egypt and Greece. There are two main bed bugs that can make for a miserable night: the common bed bug and the tropical bed bug. Before the 1940's, bed bugs were widely considered a major pest throughout the world—hence the rhyme. Around World War II however, a variety of insecticides—the most famous, or perhaps infamous of which was DDT—were invented and quickly made a serious dent in bed bug populations to the point where the parents today who say that famous rhyme have probably never seen a bed bug. Well, at least until recently.

With the banning of DDT and the increasing awareness that insecticides can have serious long term deleterious effects for both humans and their environment, industrial strength “bug killers” are not used as widely as they were in the past. Also, as with any species, bed bugs evolve with increased resistance to insecticides, and with a pest that reproduces as quickly as bed bugs, the evolution of the species toward a more resistant bed bug can progress rapidly. As international travelers are the most common carriers of bed bugs, travelers are bringing them into international travel hub cities of the United States and from those points of infestation the bed bugs are being spread across the United States and back out to the rest of the world.

What makes the bed bug such a problem? First, bed bugs are quite small (around ¼ of an inch long at maturity), with the perfect flattened shape to fit into crevices (such as pleats in mattresses and under cushions in a sofa) so they are very hard to detect. Second, they are nocturnal, being most active between midnight and 6 AM, which is usually not the preferred time for humans to be trying to find and kill bed bugs. Third, humans bitten by bed bugs often don't realize that they have been bitten until the morning when they wake up (and the bed bugs have retreated into the safety of crevices in mattresses, sofas, etc.). Bed bugs have very sharp mouth parts that pierce the skin of the humans, and most people never wake up during the bed bug's feeding. After feeding, the bed bug moves away and finds a crevice to hide in and digest its blood meal, which, depending upon conditions can sustain the bed bug for over a year.

Why is it so hard to stop the bed bug? We need look only to the bed bug life cycle to see why this pest is here to stay. A common description of a species that reproduces quickly is “they breed like rabbits”. This phrase really should be “they breed like bed bugs”, as the bed bug reproductive cycle makes rabbits look like the average nunnery in terms of reproductive restraint.

If you can ignore the painful itches that result from a night with bed bugs in your bed, you can only marvel at this reproductive machine. A female bed bug can go from an egg to a sexually mature bed bug in around three weeks. After she becomes mature, each female can lay up to twelve eggs each day. And while female bed bugs require a meal of blood to lay eggs, even without blood a bed bug can live for a long time.

While the discomfort to a human who has been bitten by bed bugs cannot be trivialized, the commercial implications and legal liabilities of a bed bug infestation are enormous. All it takes is one Trip Advisor® review complaining about bed bugs and a hotel will probably get rid of its bed bugs as there will be so few paying guests, the bed bugs will have nothing to eat and will die of starvation—but starvation could take over a year. For an apartment complex, a reputation as a place that has bed bugs can lead to huge problems remedying both the bed bug situation and the apartment complex's reputation.

2. Prior Art

There is considerable prior art that attempts to kill bed bugs through various insecticides. Insecticides may kill bed bugs, but still have the same inherent problem that was seen with DDT: the better the insecticide is at killing bed bugs, the more dangerous it is for non-bed bug types of life and the worse it is for the environment. The prior art also has a variety of physical traps often containing sticky surfaces, and carbon dioxide or other lures. As with any trap, it is only going to catch some of the bed bugs, and considering the quick growth and reproductive capabilities of bed bugs, traps will usually only limit—not eliminate—the problem especially as the bed bugs typically infest areas inaccessible to placing traps. As a purely commercial issue, it is likely that a hotel that has bed bug traps under its beds would be shunned by guests, particularly if the guest checked a trap and found a bed bug in it. Thus, while physical traps can be effective at helping to monitor and maintain a dwelling unit, they are not a satisfactory solution to killing bed bugs and preventing bed bug infestations in the first place.

There is also prior art that teaches the use of heat to kill bed bugs. One reason why bed bugs are not such a problem in desert regions of the world is that temperatures of, depending the source of information, between 113 and 120 degrees will kill all stages of bed bugs, from eggs to larvae to adults. Thus, Borrego Springs, Calif., where a cool summer day is only 115 degrees, does not have the problems with bed bugs that nearby Los Angeles, which only gets above 100 degrees rarely, has to endure. The current prior art calls for sealed enclosures into which heat is pumped. While this may prove effective, it requires the moving of specific equipment into an infested area for elimination of the bed bugs and can prove bulky, inefficient, and create additional risk of technicians spreading bed bugs during the process. There is also the danger that during the removal of, say, a sofa, bed bugs or their eggs could fall off the sofa as it is being moved, and then move right back into the “sanitized” environs to once again re-infest the sofa once it is returned from the heat chamber.

Thus there has existed a long-felt need for an effective means by which bed bugs can be killed, and an equally important need for a means by which bed bugs can be deterred from moving into a living unit that is currently uninfested. It should be understood that “living unit” is a term that is intended to encompass single family homes, multi-unit buildings such as hotels and apartments, cruise ships, airplanes, busses, theaters, delivery vehicles—basically anywhere that a bed bug could live or hitch a ride.

The invention provides just such a solution by addressing both the goal of preventing the initial infestation by bed bugs, and effectively treating bed bugs once they have become established. There are a number of devices and methods contemplated by this invention, all of which can be used alone or in conjunction with other devices and methods described herein.

By way of a brief summary of the invention, we disclose in this application a series of heating devices and methods for eliminating bedbugs. The first aspect of the invention involves putting heating elements in or around commonly infested items of furniture, such that a user concerned about preventing infestations or treating an existing infestation needs only to “plug in” the item to a wall socket and the furniture is heated beyond the mortal limits of bed bugs. The same technology can be applied to common points of transmission, such as luggage racks and commercial hampers, to stop a bed bug invasion should someone bring a bed bug-infested suitcase into a hotel, for example.

Another aspect of the invention covers enclosures, both containing heating elements/reflective sides and not, which can be used to encapsulate an item for effective elimination of bed bugs as it would prevent the bed bugs from escaping during heat treatment. Bed bugs move quickly and will run from potentially lethal heat, so just heating a mattress may not be enough if the bed bugs can just jump off and run into the box spring. The invention also contemplates the use of these methods for single family homes, multi-unit dwellings, and even trains, planes and automobiles, as well as smaller, portable items such as suitcases and rolling luggage carriers.

In more detail, the invention includes:

#1 Heating Elements in Items.

The invention calls for heating elements to be placed inside and/or outside of items, such as mattresses, box springs, headboards, sofas, plush chairs, most likely to be infested with bed bugs, such that the items can be easily and safely heated to a temperature that will kill all stages of bed bugs. Heating elements could be installed both in the fabric portion of the item and in the legs, such that no bed bug could survive climbing up the leg to infest the fabric portion of the item. Among the contemplated methods of heating include having the springs themselves be manufactured capable of being heated up, or loosely run heating elements through the springs. Alternatively, wires capable of being heated to lethal temperatures could be run over, or through the padded sections of furniture. Safety features would include some sort of temperature regulator as well as an override in the event the item got too hot. The invention could also be manufactured with a receptacle plug which could be built into the side of the item, or as a complete set, with a retractable electrical cord that could be stretched to the nearest electrical outlet. Since bed bugs tend to nest on the fabric and wood sections of the mattress, box springs and headboard of a bed, having heating elements on the exterior of the items is a preferred embodiment of the idea. It is also contemplated having two or more articles of furniture that zip together to create a larger heating chamber. For example, a box spring and a mattress could be zipped together to make the heating more efficient and to prevent the bed bugs from finding a place to hide.

A preferred embodiment of this idea involves placing heating coil(s) in mattresses. Mattresses have an interior springing core, made springy either through springs or the type and arrangement of foam in the core, a layer of padding over the core, and a fabric cover over the padding. Heating the mattress to eliminate bed bugs can be accomplished in one of two ways. First, heating coils can be laid on the surface of the mattress, on top of the padding and below the fabric cover and, through a thermostat, be programmed to heat the surface of the mattress to, say, 120 for an hour. Heating coils could be located on the sides of the mattress as well, so that the bed bugs would not have anywhere to run to. It is also contemplated that the box spring could be similarly heated with coils. There would also be a temperature sensor integrated into the units that would serve two purposes—1) ensure the chosen temperature is reached for the designated amount of time to ensure a fatal dose of heat to the bed bugs, and 2) as a safety override to monitor and shut off or scale down the heating process to ensure that the devices never exceed designated heat levels and cause any dangerous consequences from excessive temperatures.

The second method of heating a mattress is to place the coils inside the layer of padding. This would have the advantage of first, more easily heating the entire mattress to more effectively kill bed bugs, and second, be more comfortable to the user as the heating coils would be covered by some padding as well as the fabric cover. It is also contemplated that heating coils could be located on both the interior and exterior surfaces simultaneously to provide an even more effective elimination of bed bugs.

#2 Heating Elements in Common Bed Bug Transmission Points.

The invention also calls for heating elements to be placed in luggage racks, suitcase stands and other transmission points of initial infestation, such that any bed bugs leaving a suitcase would be killed before they made their way to a mattress or other suitable home.

#3 Enclosures to increase Effectiveness of Bed Bug Heat Treatment.

Another aspect of the invention calls for mobile enclosures to be placed around infested items and can be vacuum sealed around an item to be heated. The vacuum sealing will remove air spaces such that the heating process is more efficient, and the enclosures preferably have reflective sides to help trap the heat (as well as the bed bugs) to more efficiently raise the temperature high enough to kill the bed bugs. This idea could be used in combination with the heating elements of #1 above, such that the enclosure could prevent bed bugs from escaping the item as the temperature rose. Bed bugs are fairly mobile, so it would be inefficient to heat and item and yet give the bed bugs an opportunity to escape before the temperature became fatally high. One possible method of creating the vacuum shrinking would be to use an inflatable bed pump in reverse. It is also contemplated that this device and method could be used as an effective means of containing the bed bugs while transporting a mattress or other item of furniture to a location (either mobile or fixed) where it could either be further heat treated to eliminate the bed bugs or safely disposed of.

Enclosures that contain heating elements to be used either independently or in conjunction with use/device #1 above. It is also conceived that an enclosure such as a mattress cover could be manufactured with heating elements contained in the cover itself. A preferred embodiment of this idea would have the enclosure being designed to fit tightly over the item to be treated, where the enclosure has an inner surface that is reflective of heat, and where the inner surface additionally has heating elements, such that heat from the heating elements reflects back off the reflective inner surface, thereby making for a more efficient heat treatment. The separate enclosures would also have the capacity to be zipped together to cumulatively create larger heated environments to accommodate larger single articles or multiple smaller articles, all clothes in a closet, linens, pillows, cushions, etc., in one heating treatment for added speed and efficiency.

#4 Mobile Heat Enclosure Treatment Services.

The invention also provides for mobile vehicles, such as vans, trailers, step-vans and trucks, that have enclosures with heating elements in beds, bodies and roofs, such that they could drive to an infested home or multi-unit complex, have the infested items placed in the mobile enclosure, and heat the items to a temperature that would kill all phases of bed bugs.

#5 Heatable Luggage and Other Travel Items.

Since traveling is the main way bed bugs are spread, an additional element of the invention calls for luggage and other items used in traveling to be built with heating elements built into the sides, such that by simply plugging the item into a wall socket, it can be heated adequately to a) kill any bed bugs inside, b) prevent any bed bugs inside from infesting the hotel room or other place the traveler is visiting, and c) prevent any bed bugs residing in that hotel room from hitching a ride out on the traveler's suitcase. This could be easily done, as the guest would arrive, plug the suitcase into the electrical outlet and ensure that the enclosed contents were heat treated and no living bed bugs made it into or out of the suitcase. It is also possible to utilize the enclosures of #3 to enclose a suitcase or other typical piece of travel luggage such that by leaving it on a heated luggage stand, and bed bugs in the luggage would be killed by the heat and not have a chance to escape.

#6 Commercial Applications.

The invention also provides for heating elements to be built into various machines and items commonly used in homes, multi-unit dwellings such as hotels and apartment buildings. For example, laundry hampers could have heated elements in them that not only provided warm towels and laundry, but also killed any bed bugs on the towels and/or laundry. Other examples include luggage storage rooms in hotels, trunk liners for taxis, and flooring in areas most likely to be in first stage contact with incoming bed bugs as well as heating bus and taxi seats, floor mats, and rolling luggage carriers in hotels.

It should be specifically noted, again, that the most effective way to prevent bed bug infestations and to terminate all bed bugs in an already-infested location may be to combine two or more of the above-mentioned devices and methods.

### SUMMARY OF THE INVENTION

The current invention provides just such a solution by having a variety of devices and methods, usable both alone and in conjunction with other devices.

It is a principal object of the invention to provide a combination of a commonly-infested item with a heating element, built either inside or on the exterior, or both, of the item, such that a user can simply plug in the heating element and heat the item to a temperature that will kill all stages of bed bugs.

It is another object of the invention to provide a mattress, box spring, headboard, sofa, chair or other commonly infested item of furniture with a heating element, either internal and/or as a close fitting external sheath or cover, which can regulate the temperature and duration of a heating to more effectively kill bed bugs.

A further object of the invention is to provide a design by which commonly infested items can have heating elements built into them as part of the manufacturing process.

An additional object of the invention calls for heating elements to be either manufactured into, or retroactively added to, common points of transmission for bed bug infestations, such as luggage stands and carts at hotels.

Another object of the invention is to provide an enclosure that will cover an infested item and allow for more efficient heating.

A further object of the invention provides an enclosure that can be vacuum-shrunk around the infested item with the goal of both preventing bed bugs from escaping their fate and retaining the heat being used to kill the bed bugs.

Another object of the invention calls for an enclosure that is made in common sizes, such as the different sizes of mattresses available, and allow those different size modules to be connected/zipped together to increase the size of enclosed heated areas and optionally contain an inner, reflective surface and one or more heating elements.

Another object of the invention is to provide for mobile bed bug-termination vehicles that contain chambers into which infested items can be placed and heated up to bed bug-killing temperatures for a period of time suitable for killing all life phases of the bed bug. The commonly contemplated vehicles would include vans and trucks.

A further object of the invention is to provide a design for the construction of suitcases and other commonly used travel articles with heating elements built into the item, such that a user can simply plug in the item at home, a hotel or other travel spot and both prevent bed bugs from escaping from the item and infesting the home, hotel or other travel spot and preventing any bed bugs from infesting the item itself.

Another object of the invention is to provide commercially-used points of infestation, such as laundry hampers in homes or laundry carts in commercial laundries, with internal or external heating elements such that any bed bugs residing on towels or other commonly shared items that could be a transmission source can be terminated by the heat of the laundry hamper or other item.

It is a final object of this invention to provide a chemical-free, cost effective, and efficient way to eliminate bed bug infestations, and prevent infestations from occurring in the first place.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a perspective view of a mattress with external heating elements on the top, bottom and sides.

FIG. 2 is a perspective, cut-away view of a mattress with internal heating elements.

FIG. 3 is a side view of a luggage rack 54 with heating elements.

FIG. 4 is a perspective, partial cut away, picture of a piece of luggage with side heating elements built into the sides of the luggage and edge heating elements built into the edges of the luggage.

FIG. 5 is a perspective view of a suitcase covered by a form-fitting enclosure.

FIG. 6 is a perspective view of a chair covered with a large, straight-sided enclosure, generally referenced as, which preferably can be made in the shape of a cube or rectangular prism, that can be placed over an infected item and all the air removed with a pump, such as a vacuum pump, to facilitate heat treatment of the item. It should be noted that this aspect of the invention can have reflective internal sides, its own heating elements, or just the shape to prevent bed bugs from escaping the heat being generated by the item itself.

### DETAILED DESCRIPTION OF THE INVENTION

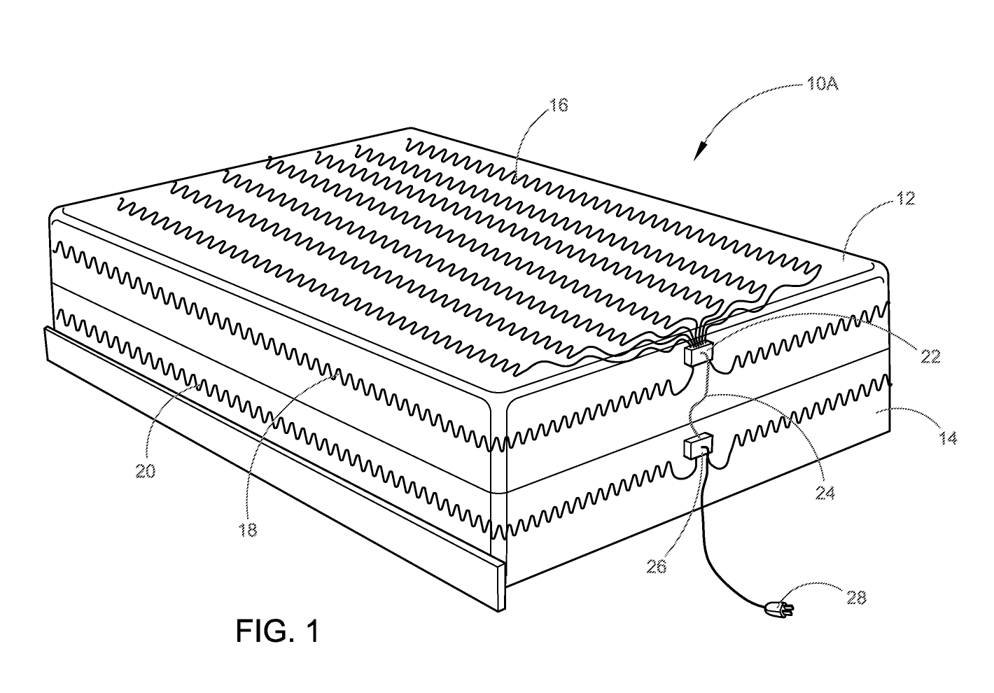

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings. FIG. 1 is a perspective view of a mattress with external heating elements on the top, bottom and sides. In this version, the exterior surfaces of a mattress 10A are covered with heating coils 16. The heating coils 16 lie across the top surface 12 of a mattress and terminate in a plug-like receptacle/thermostat 26, into which a cord 28 can be plugged to a convenient wall socket. There is also a thermostat 24, which can be adjusted to determine the temperature at which the mattress is to be heated and the duration of the heating. It is also contemplated that there could be additional heating coils 18 located on the side of the mattress, and/or on the side 20 of the box spring 14. It is also contemplated that a combination mattress/box spring item could be created where the bottom of the mattress is zipped or otherwise attached to the top of the box springs, creating a contiguous “heating chamber” which prevents bed bugs living on one unit to find sanctuary in the other unit.

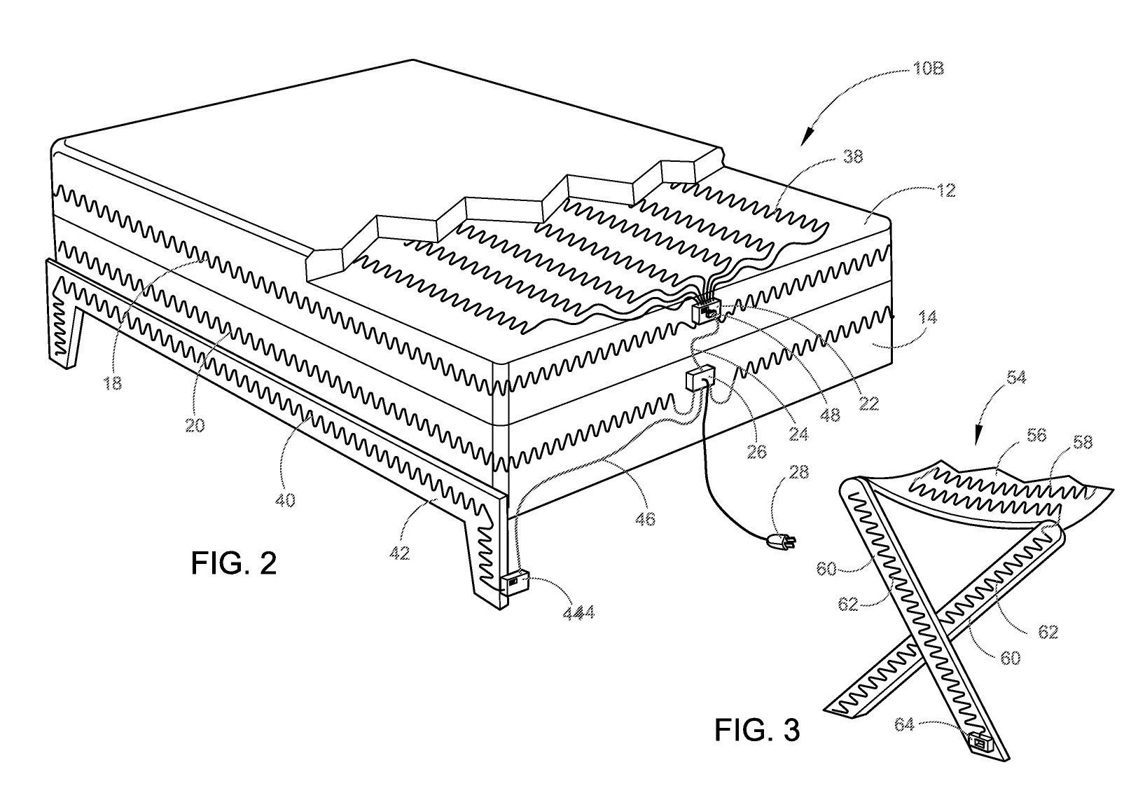

FIG. 2 is a perspective, cut-away view of a mattress with internal heating elements. In this embodiment of the invention, the heating elements 38 are inside the mattress 10B. These heating elements 38 are embedded within the mattress and extend horizontally along a plane several inches, or on top of the “core” of the mattress 12 below the surface of the mattress. There can also be heating elements 18 along the side of the mattress, giving it the ability to kill bed bugs from both inside and outside the mattress. As with the embodiment illustrated in FIG. 1, there is a receptacle/thermostat 26 to regulate temperature on the box spring and a thermostat 48 to regulate the intensity and duration of the heating on the mattress. The side 14 of the box spring can also have heating elements 20 to kill bed bugs hiding in this location. The stand 42 for the bed can also have heating elements 40 along the exterior of the wood or metal to both kill bed bugs residing in the stand, and to prevent bed bugs from climbing the legs of the stand to infest the box springs or mattress. This illustration also shows how more than one thermostat 444 can be used to regulate different temperature regimes for different parts of the bed. Here, an electrical connector 46 connects the thermostat 444 of the bed stand to the thermostat of the mattress and box springs 26. This embodiment of the invention will not only allow a user to kill existing bed bugs on the unit, but also, through heating the legs, prevent an infestation of bed bugs in the first place. The heated mattresses can also be used at a lower setting to heat beds in cooler climates, providing a dual use of luxurious comfort as well as resistance to bed bug infestation.

FIG. 3 is a side view of a luggage rack 54 with heating elements. The luggage rack 54 is a common point of infestation from bed bugs in hotels, as often guests will unknowingly bring in bed bugs on their suitcases. It is contemplated that the luggage rack could be heated either internally and/or externally, and with leg heating elements 62 on the legs 60 of the unit and saddle heating elements 58 for the saddle portion 56. By heating the luggage rack 54 with heating elements, the hotel can prevent bed bugs from leaving the suitcase and traversing the luggage rack to get to the beds or other suitable locations for living and reproduction. This aspect of the invention also has a thermostat/receptacle 64 into which an electric plug can be inserted to heat the unit and regulate the temperature therein. It is also contemplated that there could be two separate thermostats to allow for different temperatures to the leg and saddle portions of the luggage stand.

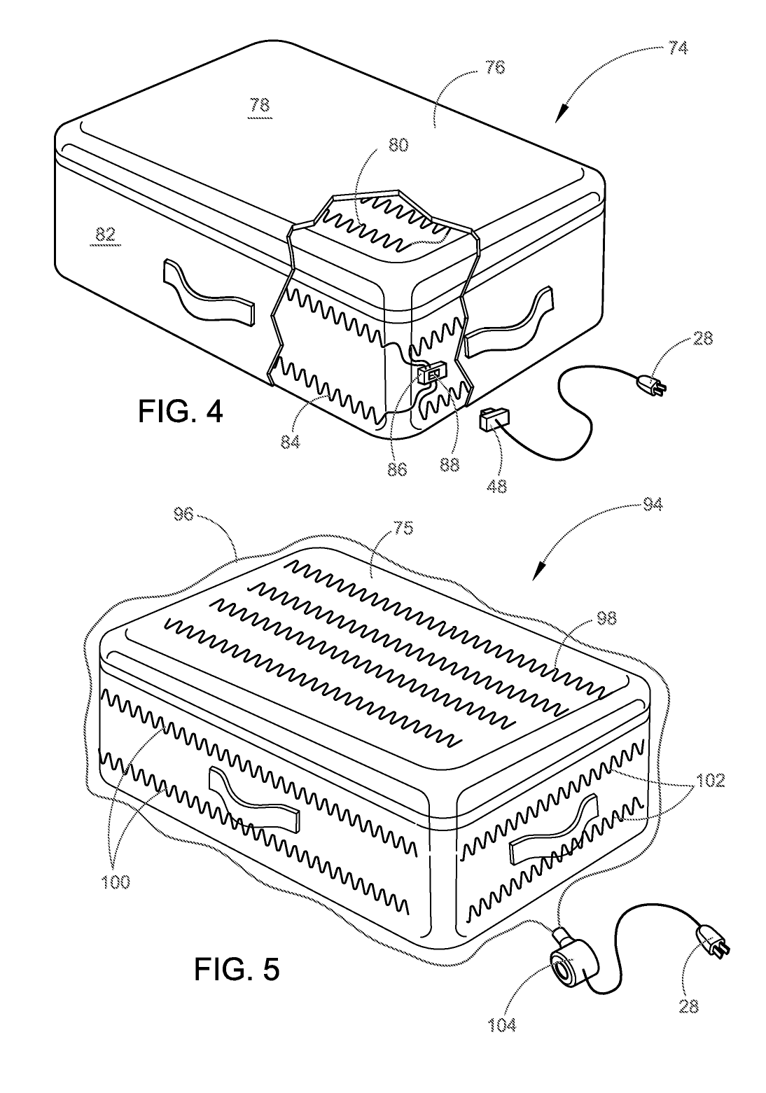

FIG. 4. is a is a perspective, partial cut away, picture of a piece of luggage 74 with side heating elements 80 built into the sides 78 of the luggage and edge heating elements 84 built into the edges 82 of the luggage. As with the mattress version of the invention, the luggage version has a plug 88 and a thermostat 86. An external plug 28 has an end 48 that mates with the plug 88 on the suitcase, allowing a use to travel to a new location, then remove the plug 88 from the suitcase, hook it up, get the electricity running, and heat up the suitcase through its edges, thereby both killing any bed bugs traveling in the suitcase so they do not infest the hotel room, and preventing any bed bugs in the hotel room from infesting the suitcase. It is also contemplated that there could be a version of the invention where the heating elements are located inside of the hard shell and the hard shell could also include a reflective inner layer (not shown in this version, but contemplated in as being optional in every aspect of the invention and method of using the invention discussed in this patent application and the related provisional application), that would reflect the heat from the elements into the interior of the suitcase, thereby killing any bed bugs in the contents of the suitcase as well as any bed bugs living in the shell of the suitcase.

FIG. 5 is a perspective view of a suitcase 75 covered by a form-fitting enclosure 96. It should be stressed that the method described in this figure could be applied to mattresses, box springs, entire beds, and any other item that a user of the invention desires to cleanse of bed bugs. The enclosure, generally referenced as 94, has an outer layer 96 that is rugged and impermeable to bed bugs, an internal reflective layer (not shown in this illustration), and one or more heating elements positioned inside of the reflective layer. In this particular embodiment of the invention, the form-fitting enclosure 94 covers the suitcase 75 so tightly that there is little free space to be heated and the interior of the enclosure has heating elements on both the side portions 98 and the edge portions 100 and 102. The air inside of the enclosure is evacuated through a pump 104 which can be plugged into a convenient electrical outlet through a plug 28. The enclosure 94 also prevents bed bugs from escaping their heated demise once the heating elements are turned on. It should be noted that this heat enclosure can be put over the heated mattresses illustrated by FIGS. 1 and 2, and the heated suitcase of FIG. 4, so as to make the killing process more effective.

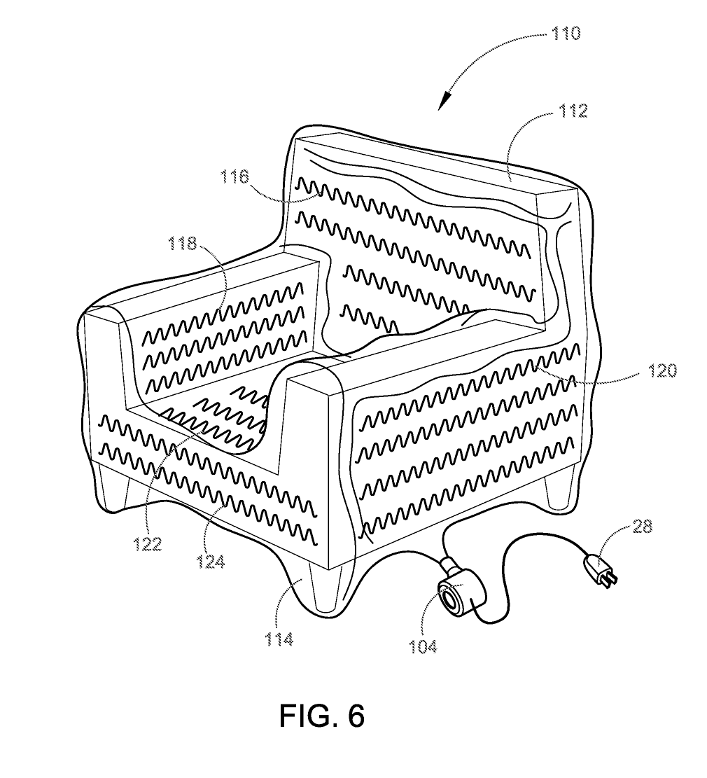

FIG. 6 is a perspective view of a chair 112 covered with a large, straight-sided enclosure, generally referenced as 110, which preferably can be made in the shape of a cube or rectangular prism that can be placed over an infected item and all the air removed with a pump 104, such as a vacuum pump, to facilitate heat treatment of the item. It should be noted that this aspect of the invention can have reflective internal sides, its own heating elements, or just the shape to prevent bed bugs from escaping the heat being generated by the item itself. The invention has a funnel-like tube that connects the pump to the enclosure. The pump can be plugged into any nearby electrical outlet through its cord 28. In this particular embodiment of the idea, the enclosure is fitted over the entire chair, including not only the cushion portions but also the legs 114. Here, there are heating elements on the inner side of the enclosure that correspond to the backrest 116, inner armrests 118, outer armrests 120, seat 122 and front 124 portions. After the excess air is sucked out of the enclosure by the pump, any bed bugs living in the chair will be trapped and unable to escape, thereby allowing the heating elements to kill them effectively and not allow them to jump off this particular chair and find their way to another.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. An article of furniture, where the article of furniture comprises six sides: a front side, a back side, a top, a bottom, a right side and a left side, and the article additionally comprises a core, a quantity of padding, where the quantity of paddling is located on a surface of the core, a covering fabric, where the covering fabric is located on an outside surface of the paddling, an exterior surface, where the exterior surface is located outside of the core and padding but inside of the covering fabric, and an interior surface, where the interior surface is located such that it is covered by at least some of the quantity of padding and is inside the covering fabric, additionally comprising one or more electric heating coils, a thermostat and a plug, where, a user of the invention can plug in the plug to an electrical outlet, where the plug can transfer a quantity of electricity to the electrical heating coils, and a quantity of heat can be generated by the one or more electrical heating coils and the quantity of heat is regulated by the thermostat and where the quantity of heat generated has an upper limit.

2. The article of claim 1, where the one or more electrical heating coils are located on the exterior surface of the article.

3. The article of claim 2, where the one or more electrical heating coils is at least two in number and the at least two electrical heating coils and located on at least two of the six sides.

4. The article of claim 2, where the one or more electrical heating coils is at least five in number, and the at least five electrical heating coils are located on at least five of the six surfaces.

5. The article of claim 4, where the article is a mattress and at least five of the six surfaces of the mattress comprise at least one electrical heating coil.

6. The article of claim 5, where the mattress comprises a plurality of electrical heating coils on the top surface and at least one electrical heating coil on the front side, the back side, the right side and the left side.

7. The article of claim 5, where the upper limit of the quantity of heat is at least 113 degrees Fahrenheit.

8. The article of claim 5, where the upper limit of the quantity of heat is at least 120 degrees Fahrenheit.

9. The article of claim 1, where the one or more electrical heating coils are located on the interior surface of the article.

10. The article of claim 9, where the one or more electrical heating coils is at least two in number and the at least two electrical heating coils and located on at least two of the six sides.

11. The article of claim 9, where the one or more electrical heating coils is at least five in number, and the at least five electrical heating coils are located on at least five of the six surfaces.

12. The article of claim 11, where the article is a mattress and at least five of the six surfaces of the mattress comprise at least one electrical heating coil.

13. The article of claim 12, where the mattress comprises a plurality of electrical heating coils on the top surface and at least one electrical heating coil on the front side, the back side, the right side and the left side.

14. The article of claim 13, where the upper limit of the quantity of heat is at least 113 degrees Fahrenheit.

15. The article of claim 13, where the upper limit of the quantity of heat is at least 120 degrees Fahrenheit.

16. The article of claim 1, where there are at least two electrical heating coils, and at least one of the at least two electrical heating coils is located on the exterior surface of the article and at least one of the at least two electrical heating coils is located on the interior surface of the article.

17. The article of claim 16, where the one or more electrical heating coils is at least ten in number, and the at least five electrical heating coils are located on at least five of the six exterior surfaces and at least five electrical heating coils are located on at least five of the six interior surfaces.

18. The article of claim 17, where the article is a mattress and at least five of the six interior surfaces of the mattress comprise at least one electrical heating coil and at least five of the six exterior surfaces comprise at least one electrical heating coil.

19. The article of claim 18, where the upper limit of the quantity of heat is at least 113 degrees Fahrenheit.

20. The article of claim 18, where the upper limit of the quantity of heat is at least 120 degrees Fahrenheit.

21. The article of claim 1, where the one or more electrical heating coils are located on the exterior surface of the article, where the one or more electrical heating coils is at least five in number, and the at least five electrical heating coils are located on at least five of the six surfaces, where the article is a chair and at least five of the six surfaces of the chair comprise at least one electrical heating coil.

22. The article of claim 21, where the chair additionally comprises a plurality of electrical heating coils on the top surface and at least one electrical heating coil on the front side, the back side, the right side and the left side, and where the upper limit of the quantity of heat is at least 120 degrees Fahrenheit.

23. The article of claim 1, where the one or more electrical heating coils are located on the interior surface of the article, where the one or more electrical heating coils is at least five in number, and the at least five electrical heating coils are located on at least five of the six surfaces, and where the article is a chair and at least five of the six surfaces of the chair comprise at least one electrical heating coil.

24. The article of claim 23, where the chair comprises a plurality of electrical heating coils on the top surface and at least one electrical heating coil on the front side, the back side, the right side and the left side, and where the upper limit of the quantity of heat is at least 120 degrees Fahrenheit.

25. A combination article, comprising an upper article and a lower article, where the upper article of furniture comprises six sides: a front side, a back side, a top, a bottom, a right side and a left side, and the upper article additionally comprises a core, a quantity of padding, where the quantity of paddling is located on a surface of the core, a covering fabric, where the covering fabric is located on an outside surface of the paddling, an exterior surface, where the exterior surface is located outside of the core and padding but inside of the covering fabric, and an interior surface, where the interior surface is located such that it is covered by at least some of the quantity of padding and is inside the covering fabric, additionally comprising one or more electric heating coils, a thermostat and a plug, where, a user of the invention can plug in the plug to an electrical outlet, where the plug can transfer a quantity of electricity to the electrical heating coils, and a quantity of heat can be generated by the one or more electrical heating coils and the quantity of heat is regulated by the thermostat and where the quantity of heat generated has an upper limit, and where the lower article of furniture comprises six sides: a front side, a back side, a top, a bottom, a right side and a left side, and the lower article additionally comprises a core, a quantity of padding, where the quantity of paddling is located on a surface of the core, a covering fabric, where the covering fabric is located on an outside surface of the paddling, an exterior surface, where the exterior surface is located outside of the core and padding but inside of the covering fabric, and an interior surface, where the interior surface is located such that it is covered by at least some of the quantity of padding and is inside the covering fabric, additionally comprising one or more electric heating coils, a thermostat and a plug, where, a user of the invention can plug in the plug to an electrical outlet, where the plug can transfer a quantity of electricity to the electrical heating coils, and a quantity of heat can be generated by the one or more electrical heating coils and the quantity of heat is regulated by the thermostat and where the quantity of heat generated has an upper limit.

26. The combination article of claim 25, where the upper article is a mattress and the lower article is a box spring, and where the mattress additionally comprises at least five electrical heating coils, and the at least five electrical heating coils are located on at least five of the six surfaces, and where the box spring has at least five electrical heating coils, and the at least five electrical heating coils are located on at least five of the six surfaces.

27. The combination article of claim 26, where the mattress has at least five electrical heating coils on its top side, and at least one electrical heating coil on its back side, its front side, its right side, and its left side, and where the box spring has at least five electrical heating coils on its bottom side and at least one electrical heating coil on its back side, its front side, its right side, and its left side.

28. The combination article of claim 27, where the mattress additionally comprises mattress joining means, and where the box spring additionally comprises box spring joining means, and where the mattress joining means can mate with the box spring joining means to create a single object.

29. The combination article of claim 28, where the joining means are zippers.
